(19) United States
(12) Patent Application Publication
(10) Pub. No.: US 2021/0113979 A1
(43) Pub. Date: Apr. 22, 2021

(54) GRANULATION DEVICE

(71) Applicants: thyssenkrupp Industrial Solutions AG, Essen (DE); thyssenkrupp AG, Essen (DE)

(72) Inventors: Thorsten SCHOEN, Lünen (DE); Daniel MIKAUTSCH, Dortmund (DE)

(73) Assignees: thyssenkrupp Industrial Solutions AG, Essen (DE); thyssenkrupp AG, Essen (DE)

(21) Appl. No.: 16/608,663

(22) PCT Filed: Apr. 18, 2018
(86) PCT No.: PCT/EP2018/059925

§ 371 Date: Oct. 25, 2019

(30) Foreign Application Priority Data
Apr. 27, 2017 (DE) 10 2017 207 131.1

(51) Int. Cl. B01J 2/10; B01J 2/16; B01F 7/04; B01F 7/00; C05G 5/12; C05C 3/00

(52) U.S. Cl. CPC B01J 2/10; B01J 2/16; B01F 7/043; B01F 2215/0055; C05G 5/12; C05C 3/005; B01F 7/00291

(57) ABSTRACT

A device for granulation of concentrated and/or aqueous solutions/melts may include a shaft extending in a longitudinal direction and rotatably mounted within a housing. Impact arms may extend radially outward from a rotation axis of the shaft. Due to blade elements attached to the impact arms, particles of fluidized material to be treated may advance in the longitudinal direction along a flow direction and be rotated and mixed by the blade elements. A first blade element may have an attitude so as to be inclined relative to a plane that in a transverse direction extends through the rotation axis, when viewed in the conveying direction. A second blade element may have an attitude that is counter to the flow direction such that the second blade element when viewed in the conveying direction is aligned so as to be reversely inclined relative to a remainder of the blade elements.

The present invention relates to a device for the granulation of concentrated and/or aqueous solutions/melts, in particular for the production of fertilizer granules, comprising a trough-type housing, at least one shaft that is aligned in the longitudinal direction being rotatably mounted in the interior of said housing, wherein the shaft is provided with a plurality of impact arms which from the rotation axis of the shaft extend approximately radially outward, wherein the impact arms or parts thereof are configured as blade elements, or blade elements are attached to the impact arms, the external contours of said blade elements moving on an imaginary surface of a rotation body, wherein on account of the disposal of the blade elements particles of the material to be treated for fluidizing that are introduced into the trough-type housing are advanced in the longitudinal direction of the housing (flow direction) and the particles of the material to be treated are simultaneously agitated and mixed by the blade elements, wherein at least one of the blade elements in relation to a plane that in the transverse direction runs through the rotation axis of the shaft is set by way of an attitude in such a manner that said at least one blade element, when viewed in the conveying direction of the material to be treated, is aligned so as to be inclined.

The present invention relates to the production of fertilizer granules such as, for example, ammonium nitrate (AN), calcium ammonium nitrate (CAN), ammonium sulfate nitrate (ASN), and the like. The fertilizers mentioned represent a source of nitrogen or sulfur, respectively, which are important plant nutrients.

A multiplicity of trace elements in the form of metal cations continue to be necessary for the growth of plants and the personal health of consumers. Said trace elements can be introduced in a defined concentration into a fertilizer, for example in the form of ammonium nitrate granules, and thus be made available to the soil, the plants, and ultimately to the human food chain.

A few definitions which are used in the technical field of fertilizer granules, to which the present invention relates, are to be reproduced hereunder.

Fertilizer—this is understood to be the primary components of the granulate which typically account for more than 95% of the dry matter of said granulate.

Granulation additives—these include all components which in small quantities, typically in total, account for less than 5% of the dry matter of the granulate, are accommodated in the fertilizer, and have various functions.

Granulation agents—these are understood to be granulation additives of which the function lies primarily in improving the granulation capability of the fertilizer, reducing the amount of dust, and in improving the granulate properties (for example, compressive strength, granule structure, surface characteristic).

Granules preferably comprise particles which are uniformly shaped and homogenously constructed, wherein the characteristic and the physical behavior thereof are known to the person skilled in the art. The grains of a granulate can assume various sizes, wherein the width of the grain size distribution typically represents a criterion for the quality of a granulate.

Granules of this type can have a size in the range from 2 to 5 mm, for example.

However, uniform mixing and a uniform distribution of the grain size of the individual component parts is essential in the distribution of fertilizer mixtures. An excessive width of the grain size distribution can moreover also lead to mechanical problems in the uniform delivery of the fertilizer mixture.

For these reasons, granulated fertilizers or fertilizer mixtures which moreover can be provided just briefly prior to the application by mixing the individual component parts are increasingly being used. The size of the granule particles is adapted to the urea granule which in global terms is the most widely used fertilizer.

The granulation in the context of the present invention takes place by fluid-bed granulation. The granulation by means of fluid-bed granulation, comprising for example the steps:
providing germs which contain substances that are provided for fertilizer granulate;
fluidizing said germs in the fluid bed; and
spraying or metering onto the germs a composition that is provided as an aqueous solution and/or a concentrated solution and/or a melt, containing substances that are provided for the fertilizer granulate and optionally at least one granulation additive and/or granulation agent.

The germs of the granulate are fluidized in a fluid bed. A fluid bed is suitable for a multiplicity of processes in the field of process technology for treating solids and liquids, and the construction of said fluid bed is known to the person skilled in the art. The fluid bed according to the invention is formed by the germs which contain substances that are provided for the fertilizer granulate, and the germs are mechanically rendered to a fluidized state by way of the impact arms/blade elements of the device. A fluid-like state of the germs is generated herein.

A screw granulator having a housing, two horizontally disposed shafts being rotatably mounted in the interior of said housing, is known from DE 101 40 139 A1. Each shaft is populated by a multiplicity of arms which extend so as to be perpendicular to the rotation axis of the shaft, wherein scraper blades are fastened to the external ends of the arms, the external contours of said scraper blades moving on an imaginary cylinder surface. On account of the disposal of the scraper blades, the particles of the material to be treated are advanced in the longitudinal direction of the housing, and the particles are simultaneously rotated and mixed by the scraper blades. Said scraper blades are slightly set by way of an attitude in relation to the plane of the orbit performed by said scraper blades. In the case of this known method, the particles of the material to be treated are mechanically fluidized by the impact arms on the rotating shafts, wherein a melt of the products to be granulated is then sprayed onto the particle bed generated by way of infeed nozzles.

The object of the present invention lies in making available a device for the granulation of concentrated and/or aqueous solutions/melts of the aforementioned type, said device enabling a targeted influencing of the product properties of the granulate produced in various terms.

The object is achieved by a device according to the invention for granulation of the type mentioned at the outset, having the features of claim 1.

According to the invention, at least one blade element/impact arm is set by way of an attitude counter to the flow direction of the fluidized material to be treated in such a manner that said at least one blade element/impact arm, when viewed in the conveying direction of the material to be treated, is aligned so as to be reversely inclined in comparison to the plurality of the remaining blade elements/impact arms on said shaft.

A first important aspect in terms of the properties of the granulate is the dwell time of the material to be treated in the granulation device. On account of the measure according to the invention, it is achieved that the material to be treated in the advancement of the latter in the longitudinal direction of the housing is imparted a certain flow resistance on the blade element set by way of a reverse attitude, and on account thereof the conveying movement is decelerated in the region of said blade element, and the dwell time of the material to be treated in the trough-type container is increased.

One preferred refinement of the device according to the invention provides that at least two shafts having in each case a plurality of impact arms are provided in the trough-type housing (container) of the granulation device, wherein at least one blade element on each shaft is set by way of an attitude counter to the flow direction of the fluidized material to be treated, and wherein the impact arms/blade elements on the first shaft are preferably positioned so as to be mirror-symmetrical in relation to those on the second shaft, and the two shafts rotate in respective opposite directions. In the case of granulation devices which comprise two rotating shafts, the effect of increasing the dwell time can be amplified on account of a total of two blade elements, at least one on each shaft, that are set by way of an attitude in such a manner. When two such rotating shafts are present in the device, in terms of the mixing of the material to be treated in the container it can be advantageous when the two shafts rotate in opposite directions, as is known per se from the above-mentioned publication DE 101 40 139 A1.

According to one preferred refinement of the invention, at least two blade elements/impact arms that are not mutually adjacent are set by way of an attitude on one shaft counter to the flow direction of the fluidized material to be treated. In the case of granulation devices in which only one rotating shaft is provided, the effect of increasing the dwell time of the material to be treated in the trough-type housing can be amplified in that two blade elements that are set by way of an attitude counter to the flow direction are disposed on the shaft. However, in order to avoid an excessive deceleration of the conveying movement of the fluidized material to be treated, or the occurrence of local turbulences, two blade elements that are set by way of an attitude counter to the flow direction of the fluidized material to be treated are preferably not directly mutually adjacent. In the case of granulation devices which comprise at least two rotating shafts having a plurality of impact arms and blade elements, two or more blade elements that are set by way of an attitude counter to the flow direction of the fluidized material to be treated and are not mutually adjacent can be present on each shaft.

According to one preferred refinement of the invention, the respective free ends of a plurality of impact arms or blade elements, respectively, of one shaft can lie on an imaginary helical line, for example. This is to be understood such that the impact arms or blade elements, respectively, on the rotating shaft are disposed in such a manner that, when viewed in the conveying direction, that is to say thus in the axial direction of the shaft, a subsequent blade element is disposed so as to be also offset in the circumferential direction in relation to a preceding blade element. However, pairs of blade elements which lie in each case so as to be mutually offset in the circumferential direction of the rotating shaft, for example so as to be mutually offset by 180° across the circumference, but when viewed in the axial direction are disposed at the same height on the shaft and thus so as to be mutually opposite, can also be provided herein, wherein in turn subsequent blade elements can be provided so as to have an axial offset and simultaneously a circumferential offset such that the above-mentioned imaginary helical line results.

One preferred refinement of the device according to the invention provides at least one perforated distribution plate for infeeding the concentrated and/or aqueous solutions/melts from above the fluidized material to be treated in a manner so as to be approximately horizontally disposed in the housing. On account of this measure, a further targeted influencing of the product properties of the granulate produced becomes possible in terms of another aspect, specifically in terms of a uniform distribution of the aqueous solution/melts infed from above across far regions of the axial length of the trough-type container.

In the case of the aforementioned variant it can also be advantageous when the installation, in particular the perforated distribution plate, for infeeding the concentrated and/or aqueous solutions/melts from above the fluidized material to be treated, when viewed in the flow direction, extends only in the front and/or in the central region of the housing of the device. No infeeding of an aqueous solution or melt from above is provided in the rear region of the housing of the device in this case, because the granulation process has already progressed further in said rear region.

In the case of a granulation device of the type according to the invention, an installation for infeeding the material to be treated for fluidizing into the trough-type housing is provided. In the case of known devices, infeeding for material to be treated is typically provided only in the rear region of the housing, that is to say upstream. By contrast, it is advantageous when, according to one preferred variant of the device according to the invention, the installation, for example for a targeted infeeding of additives to the material to be treated for fluidizing, comprises at least one, preferably two or a plurality of, mutually spaced apart ports that are disposed so as to be distributed across the length of the housing of the device. This in turn enables targeted influencing of the product properties of the granulate since, when viewed in the conveying direction of the granulate, additives can be infed in a targeted manner at more than one location and said additives can be brought into contact with the material to be treated which is already in a progressed stage of the granule-forming process.

The granulation device according to the invention preferably furthermore comprises at least one additional installation for adding ammonia water and/or water vapor onto the material to be treated for fluidizing. The properties of the granulate generated can likewise be influenced in a targeted manner on account of the addition of said additional substances. For example, when a fertilizer granulate based on calcium ammonium nitrate (CAN) is produced in the granulation device according to the invention, limestone or dolomite is advantageously used as a primary filler medium. Since this is a natural material, the quality thereof can be subject to slight variations. Since a specific reaction takes place between the filler medium and the ammonium nitrate (AN) which is directed as a melt into the granulator by way of the perforated plate so as to be able to produce granulated CAN, and said reaction is a function of the quality of the natural material and simultaneously of the reaction temperature, a possibility for responding to potential variations is achieved on account of the above-mentioned steam infeed. Furthermore, depending on the mass flow of the filler medium, a temperature correction must also be able to take place independently of the quality of the filler medium. Since the resulting product specifications in terms of the proportion of nitrogen is set by varying the mass of the filler medium, a variable setting of the temperature is required (by way of the mass of infed steam).

In order to be able to equalize variations in the quality of further filler media which serve as granulation agents for products as well as display a nitrogen proportion of more than 30% by weight, the introduction of NH₃ into the granulation phase is helpful. NH₃ water can be used herein in order for the aspects relating to safety technology to be taken into account.

At least one or a plurality of additional installations, disposed so as to be distributed across the length of the granulator, for adding ammonia water and/or water vapor is/are preferably provided above, laterally of and/or below the medium to be fluidized, said medium being impinged with the concentrated and/or aqueous solution/melt. Both the quantity as well as the direction from which the infeeding of said substances takes place, can thus be varied in a large variation width in that said substances are added only from above, for example, or only from the side, or only from below, or else a first of the mentioned substances is added from above, for example, and another substance is added from below, etc.

The granulation device according to the invention comprises at least one installation for externally heating the device. By varying the heating energy supplied, the temperature of the material to be treated can thus be controlled in a targeted manner during the granulation process and thus be varied when required so as to in turn influence the properties of the granulate in a targeted manner.

One or a plurality of impact arms and/or blade elements that are attached to the shaft are preferably positioned in the region of the outfeed zone of the shaft granulator. Positive mixing of the material to be treated can be achieved in the region of the outfeed zone, for example, on account of said measure.

One or a plurality of impact arms and/or blade elements that are attached to the shaft and set by way of an attitude counter to the flow direction of the product flow are positioned in the region of the outfeed zone of the shaft granulator. An increase in the dwell time of the material to be treated can be achieved in the region of the outfeed zone, for example, on account of said measure.

Furthermore, one or a plurality of baffle plates that influence the gas flow is/are preferably positioned in the trough-type housing of the device. Since the granulator is linked to the air system of the entire plant, wherein the primary airflow of the plant passes the product exit of the granulator, the following process conditions arise in the granulator:

The negative pressure which is generated by the above-mentioned preheated primary airflow passing the product exit of the granulator ensures a suction effect through the granulator and the line system lying therebehind (on the side of the material input). For this reason, false air in not insignificant quantities is suctioned through the granulator. In order to prevent that particles and/or additives are directly suctioned on account of this suction effect and thus do not participate in the reaction, this baffle plate serves as a type of impact plate.

Furthermore, the cross section between the blade elements and the trough-type housing is decreased to the extent that false air by virtue of the pressure loss on account of the baffle plate does not pass through between the trough and the blade elements but runs above the trough. On account thereof, premature cooling of the added solution/melt is avoided, this suppressing any premature and disadvantageous crystallization prior to coming into contact with the fluid bed.

The device according to the invention has a motorized drive by means of which the shaft or the shafts is/are set in rotation, said motorized drive being either on that end of the shaft that faces the product outfeed from the granulation device or on that end of the shaft that faces away from the product outfeed from the granulation device.

The trough-type housing can generally be described as a cuboid.

In some design embodiments herein it is possible that in particular the lower side of the housing, depending on the number of shafts installed in the interior of the housing, comprises 1 or 2 (optionally even more) convexities. In preferred design embodiments, the axes of the shafts lie in the center of the imaginary circles defined by the convexities.

In some embodiments the trough-type housing is a housing of which the external shape corresponds to a prism lying flat, in further embodiments a prism lying flat, having a trapezoidal base area. Here too, in some embodiments it is possible for the lower side of the housing (lower side of the trapezoid), as a function of the number of shafts installed in the interior of the housing, to have 1 or 2 (optionally even more) convexities. In preferred design embodiments, the axes of the shaft lie in the center of the imaginary circles defined by the convexities.

In some variants of the present invention a variation of the mutual positions of the two shafts is possible. The shafts can indeed be disposed according to the invention so as to be mutually parallel. However, a conical orientation is likewise possible, said conical orientation preferably having a corresponding modification of the paddle geometry such that the shafts on the one side, preferably the end side, of the granulator thus lie closer to one another than on the opposite end of the granulator.

One preferred design embodiment of a trough-type housing is accordingly a housing of which the external shape corresponds to a cuboid lying flat, or a prism lying flat and having a trapezoidal base area and one or two convexities that correspond to the base area of the cuboid or the trapezoid, wherein the axes of the shafts disposed in the interior of the housing, in particular on the centers or the center axes of the imaginary circles defined by the convexities.

In the case of a conical disposal of the shafts, the external shape of the trough-type housing (cuboid or prism) is preferably also adapted such that the base area of the one side of the cuboid or trapezoid in such a case is smaller than that of the other base side; this also means that the shafts that are disposed in the interior of the housing in each (imaginary) housing cross section lie in each case on the imaginary circles defined by the convexities.

A method for the granulation of concentrated and/or aqueous solutions/melts, in particular for the production of a fertilizer granulate, in which method particles of a material to be treated are fluidized in a granulation device having at least one shaft that is rotatably mounted so as to be aligned in a longitudinal direction, having a plurality of blade elements/impact arms that are attached to said shaft, wherein the material to be treated is conveyed in the longitudinal direction of the housing (flow direction) and the particles of the material to be treated are simultaneously rotated and mixed by the blade element/impact arms, is furthermore a subject matter of the present invention, wherein the dwell time of the material to be treated in the granulation device is increased according to the invention in that at least one blade element/impact arm which is aligned so as to be set by way of an attitude counter to the flow direction of the material to be treated for fluidizing is used.

The method for granulation according to the present invention is preferably carried out in a device having the aforedescribed features.

The present invention will be explained in more detail hereunder by means of exemplary embodiments with reference to the appended drawings in which:

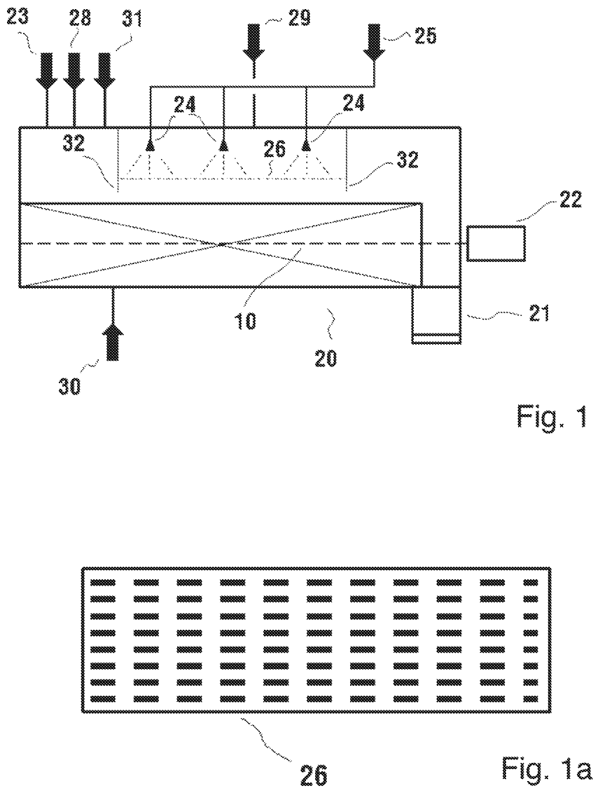

FIG. 1 shows a schematically simplified view of a granulation device according to the invention; FIG. 1a shows a detailed view of a perforated distribution plate installed in the granulation device;

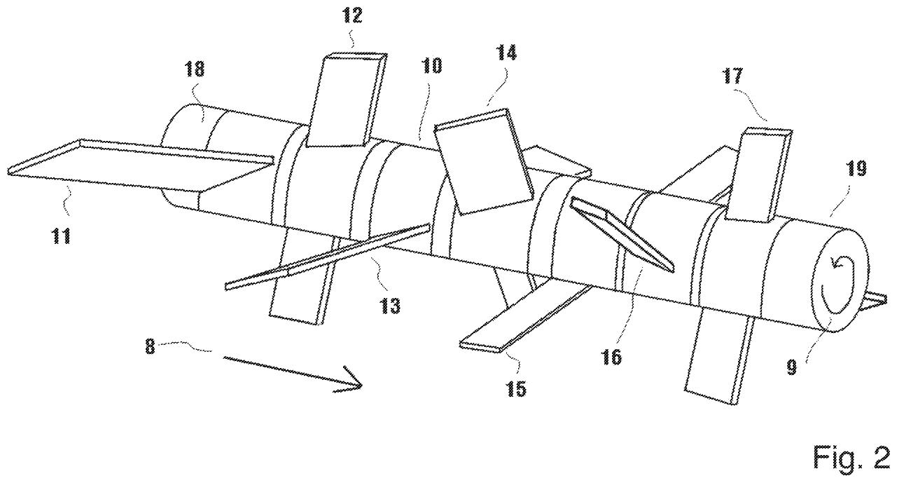

FIG. 2 shows a schematically simplified perspective view of the shaft of the granulation device according to the invention, having the blade elements/impact arms; and

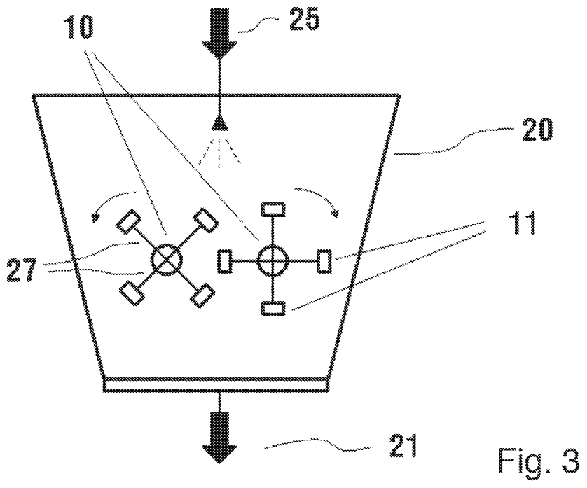

FIG. 3 shows a schematically simplified lateral view of the granulation device illustrated in FIG. 1.

The fundamental construction of a granulation device according to the invention is explained in more detail hereunder with reference to FIGS. 1 and 3. The device comprises a trough-type housing 20 in which in the present exemplary embodiment two shafts 10 are mounted so as to be rotatable about the longitudinal axis thereof, wherein the two shafts rotate in opposite directions and the blade elements/impact arms 11 that are attached to the one shaft are positioned so as to be mirror-symmetrical in relation to those on the other shaft. A motorized drive 22, for example an electric motor, which can be disposed at the outfeed end of the device is provided for the rotation of the shafts 10. The trough-type housing 20 is configured as a container and has a volume which accommodates the material to be treated for fluidizing. Blade elements/impact arms 11 are disposed on the shafts 10 in the region of the radially outer ends, said blade elements/impact arms 11 being able to be seen in the lateral view according to FIG. 3 and here being illustrated in only a schematic manner and being explained in yet more detail later with reference to FIG. 2. Instead of two shafts 10, only one shaft 10 can also be present, wherein the number of shafts depends on the size of the device, for example. The two shafts 10 in the example according to FIG. 3 rotate in opposite directions. The motorized drive 22 can also be disposed at the other end of the shafts 10 where the infeeding of fresh material to be treated takes place.

In the view according to FIG. 1 the material to be treated is conveyed from left to right such that the outfeeding of the granulate takes place in a downward manner by way of an outfeed port 21 on the right side. The infeeding of new material to be treated (oversize and undersized) takes place from above on the left side (in FIG. 1) by way of an infeed installation, this being indicated by the arrow 23. The fresh material to be treated fed in from above then drops into the trough-type housing 20 and is fluidized by way of the rotating shafts 10. A melt or an aqueous or a concentrated solution which is sprayed from above onto the material to be treated is fed to the generated particle bed by way of infeeding nozzles/spray nozzles 24, wherein a plurality of spray nozzles can be connected to one another by way of distribution pipes 25.

In the case of one potential variant of the invention, a perforated plate 26 can be disposed in the granulator such that a uniform distribution of the solution or melt is achieved when infeeding, since said solution or melt can then be fed through the perforations of the perforated plate 26 uniformly across the length and/or width of the housing in all regions instead of an only punctiform manner by way of individual spray nozzles 24. In the case of this variant, inlet pipes which can open directly onto the perforated plate 26 that distributes the solution or the melt can preferably be used instead of spray nozzles. A plan view of the perforated distribution plate 26 is illustrated as a detail in FIG. 1a. The perforation that can be seen therein represents only one potential variant. The most varied types of perforation patterns are thus possible, for example slots, bores, other geometries or combinations thereof.

The granulation device according to the invention can comprise a further infeed installation 28 by means of which additives can be introduced into the trough-type housing 20, for example from above, and be deposited on the material to be treated. Furthermore, an additional infeed installation 29 for infeeding steam and/or ammonia (water) from above onto the material to be treated can be provided. Furthermore, an additional infeed installation 30 for infeeding steam and/or ammonia (water) can also be provided in the lower region of the device such that substances of this type can also be fed to the material to be treated from below. Moreover, an infeed installation 31 by way of which filler media can be fed to the granulation procedure can be provided above the trough-type housing 20 of the device. Furthermore, one or a plurality of baffle plates 32 which influence the gas flow in the granulator can be disposed in the trough-type housing 20.

FIG. 3 shows the two counter-rotating shafts 10 when viewed in the axial direction. Impact arms 27 that extend radially outward can be provided on each shaft 10, blade elements 11 being in each case disposed on the respective radially outer ends of said impact arms 27. Said impact arms 27 and the blade elements 11 can however also form in each case a single component, that is to say that the impact arm is shaped and attached to the shaft such that said impact arm simultaneously serves as a blade element in the context of the present invention, or the blade elements, as opposed to the illustration in FIG. 3, are attached directly to the shafts 10. A variant of embodiment having blade elements 11 configured in such a manner is illustrated in FIG. 2.

The present invention will be explained in more detail hereunder with reference to the detailed view according to FIG. 2. The image in a perspective illustration and a schematically simplified manner shows a shaft 10 of a granulation device according to the invention, wherein the trough-type housing in which said shaft rotates is not illustrated here. The shaft 10 rotates about the axis thereof in the direction of the arrow 9, said axis extending so as to be centric in the longitudinal direction of the shaft 10. A number of impact arms in the form of blade elements 11, 12, 13, 14, 15, 16, 17 are attached to the shaft 10. Said blade elements have, for example, a flat plate-type shape of rotor blades, but can however also be of another shape, for example being inherently curved, of a propeller type, having a variable width, or the like. The precise shape of the blade elements is not decisive here, and a simplified flat plate-type shape is therefore illustrated in the example.

The disposal of the blade elements on the shaft influences the behavior of the material to be treated which by the shaft 10 having the blade elements is conveyed in the longitudinal direction of the housing by the rotation of the shaft in the trough-type housing of the granulator, wherein said conveying direction in FIG. 2 is identified by the arrow 8. The shaft 10, when viewed in the conveying direction, has a rear end 18 and a front end 19. A first pair of two blade elements 11 is disposed on the shaft close to the rear end, said blade elements 11 extending from the shaft radially outward. The two blade elements 11 of this first pair in terms of the circumference of the shaft 10 are disposed so as to be mutually offset by 180° such that said two blade elements 11 are approximately opposite on the circumference of the shaft. The blade element 11 that in the drawing lies in the background can therefore not be seen in the illustration of FIG. 2, while the disposal of the blade element 11 of the first pair that lies in the foreground can be readily seen. It can be seen that this blade element 11 is set by way of an attitude in relation to a plane which in the transverse direction runs through the rotation axis of the shaft. The blade element thus does not lie in this imaginary plane which would centrically intersect the cylinder shape of the shaft 10 and thus would run through the rotation axis, but said blade element is inclined in relation to said plane, specifically in such a manner that the blade element 11, when viewed in the lateral view and in the conveying direction 8 of the material to be treated, is disposed so as to be inclined upward. Moreover, the blade element that is disposed so as to be offset by 180° and is not visible is positioned so as to be rotated by 90° in relation to the visible blade element. The blade element that is not visible thus does not lie in an imaginary plane which would centrically intersect the cylinder shape of the shaft 10 and thus run through the rotation axis, but said blade element is inclined in relation to said plane, specifically in such a manner that the blade element 11 that is not visible, when viewed in the lateral view and in the conveying direction 8 of the material to be treated, is disposed so as to be inclined downward.

As a result, the fluidized material to be treated, which in the housing of the device moves in the direction of the arrow 8, in the movement of said material to be treated along the blade element 11 is subjected to a lower flow resistance.

A further pair of two blade elements 12 is disposed toward the front end 19 of the shaft 10, so as to be somewhat spaced apart from the first two blade elements 11, said further pair of two blade elements 12 again being approximately mutually opposite on the circumference of the shaft 10, which can be readily seen in this case in FIG. 2. A circumferential offset in terms of the circumference of the shaft 10 in the disposal of the two blade elements 12 in relation to the two blade elements 11 is provided herein, wherein said circumferential offset can be, for example, an angle of 90° or less, that is to say between 10° and 90°, so that the two first blade elements 11, when viewed in the conveying direction, are not aligned with the second blade elements 12 but are disposed so as to be offset to the latter. As a result, a disposal of the blade elements along a helical line ultimately results. When the shaft 10 having the blade elements rotates, the material to be treated is subjected to an advancement in the conveying direction according to the arrow 8.

The next two blade elements 13 which in the longitudinal direction of the shaft follow toward the front end 19 thereof, in turn form a pair that is approximately opposite in terms of the circumference of the shaft, wherein the blade element 13 lying in the background can only be partially seen here. These two blade elements 13 in terms of the circumference are again at attached to the shaft 10 so as to be offset in relation to the blade elements 12, wherein these two blade elements 13 are also set by way of an attitude so as to have an upward inclination, when viewed in the conveying direction (when the blade element 13 is situated so as to lie at the front, in front of the shaft, to the observer), as can readily be seen of the blade element 13 lying in the foreground. When viewed in the longitudinal direction of the shaft, a fourth pair of blade elements 14 follows so as to be somewhat spaced apart toward the front end 19 of the shaft, said pair of blade elements 14 again being set by way of an attitude, wherein a circumferential offset in relation to the two blade elements 13 lying in front is also provided here. When viewed in the longitudinal direction of the shaft, a further pair of blade elements 15 follows again so as to be somewhat spaced apart, again having a circumferential offset and being set by way of an attitude in the same manner as has been described earlier in the case of the remaining blade elements.

The blade element pairs 11, 13, 15, and 17 form an imaginary helical line. The blade element pairs 12, 14, 16 form a second imaginary helical line, wherein the blade element pair 16 is however additionally oriented counter to the flow direction.

Of the pair of two further blade elements 16 that follows toward the front end 19 of the shaft only the blade element lying in the foreground can be readily seen in FIG. 2. When comparing this blade element 16 to the blade element 11 lying in the foreground, for example, it can be seen that the blade element 16 is set by way of another attitude as compared to the blade elements 11, 13, 14, for example. Should an imaginary plane be placed transversely through the axis of the cylinder shape of the shaft 10, the blade element 16 that in FIG. 2 faces the observer is set by way of an attitude in relation to said imaginary plane such that said blade element 16, when viewed in the conveying direction of the material to be treated, is aligned so as to be inclined downward. This leads to the fluidized material to be treated on this blade element 16 being subjected to a somewhat higher flow resistance in the longitudinal direction of the shaft (conveying direction 8). This in turn leads to an increase in the dwell time of the material to be treated in the trough-type housing of the granulation device according to the invention. In the case of the present invention, this is utilized in a targeted manner for varying the dwell time of the material to be treated in the granulator in that individual blade elements 16 are set by way of an attitude at opposite angles in comparison to the remaining blade elements.

The alignment of the blade elements on the shaft 10 can be best described as follows. That end of the shaft 10 that in the flow direction of the material to be treated lies upstream is herein defined as the rear end 18 of the shaft 10. Said rear end 18 lies in the input part of the granulator, that is to say that the material to be treated makes its way into the granulator there. The front downstream end of the shaft 10 is identified by the reference sign 19 and lies in the output part of the granulator, that is to say that the material to be treated leaves the granulator there. The flow direction of the material to be treated along the shaft is identified by the reference sign 8, that is to say that the material to be treated flows from the rear end 18 of the shaft 10 to the front end 19 of said shaft 10. The rotating direction of the shaft 10 is identified by the arrow 9, that is to say that looking along the shaft 10 in the flow direction in FIG. 2, the shaft then turns in the clockwise direction. The blade elements 11, 12, 13, 14, 15, 17 that are set by way of an attitude in the flow direction in the exemplary embodiment in relation to an imaginary plane which in the transverse direction runs through the rotation axis of the shaft 10 is set by way of an attitude in such a manner that the upstream end thereof, when viewed in the rotating direction of the shaft, runs ahead of the downstream end. By contrast, in the case of the blade elements of the blade element pair 16 that are set by way of a reverse attitude and thus counter to the flow direction the downstream end of the blade element (on the right in the drawing) in the rotation of the shaft 10 runs ahead of the upstream end. This can readily be seen in the case of the blade element 16 lying in the foreground (for example in comparison to the blade element 14). The second blade element of this pair 16, lying behind the shaft to the observer, cannot be seen in FIG. 2. However, said blade element is set by way of an attitude counter to the flow direction of the material to be treated in the same way such that said blade element in the rotation of the shaft 10 by 180° is rendered congruent with the blade element 16 plotted in FIG. 2.

When the granulator comprises a second shaft, the blade elements on the latter are disposed so as to be mirror-symmetrical in relation to those according to the illustration of FIG. 2, wherein however the second shaft rotates in the opposite direction to the first shaft such that in the case of both shafts the same positioning of the blade elements in terms of the flow direction of the material to be treated and the rotating direction of the respective shaft prevails as has been described in the preceding paragraph.

A plurality of blade elements 16 can be set by way of an attitude in a manner as is shown in the context of the blade element 16 in FIG. 2, wherein however preferably not all, furthermore preferably only a minority, of the blade elements are set by way of an attitude in this shape.

### LIST OF REFERENCE SIGNS

8 Arrow (conveying direction)

9 Arrow (rotating direction)

10 Shaft

11 Blade element

12 Blade element

13 Blade element

14 Blade element

15 Blade element

16 Blade element

17 Blade element

18 Rear end of the shaft

19 Front end of the shaft

20 Trough-type housing

21 Outfeed port

22 Motorized drive

23 Infeed installation (undersize or oversize, respectively)

24 Spray nozzles

25 Distributor pipes (for steam and/or ammonia (water))

26 Perforated distribution plate

27 Impact arms

28 Infeed installation for additives

29 Infeed installation for infeeding steam and/or ammonia (water) from above

30 Infeed installation for infeeding steam and/or ammonia (water) from below

31 Infeed installation for filler media

32 Baffle plates

1.-17. (canceled)

18. A device for granulation of concentrated and/or aqueous solutions/melts, the device comprising:
a trough-type housing;
a first shaft that is aligned in a longitudinal direction and is rotatably mounted in an interior of the trough-type housing, wherein the first shaft includes impact arms that extend from a rotation axis of the first shaft generally radially outward; and
blade elements disposed on the impact arms, wherein due to the blade elements particles of material to be treated for fluidizing that are introduced into the trough-type housing are advanced in the longitudinal direction along a flow direction and are agitated and mixed by the blade elements, wherein a plane in a transverse direction extends through the rotation axis of the first shaft, wherein a first blade element of the blade elements has an attitude such that the first blade element is inclined relative to the plane when viewed in a conveying direction of the material to be treated, wherein a second blade element of the blade elements has an attitude that is counter to the flow direction of the material to be treated such that the second blade element is reversely inclined relative to the blade elements other than the second blade element when viewed in the conveying direction of the material to be treated.

19. The device of claim 18 wherein the second blade element is reversely inclined relative to the blade elements other than the first and second blade elements when viewed in the conveying direction of the material to be treated, wherein external contours of the blade elements move on an imaginary surface of a rotation body.

20. The device of claim 18 comprising a second shaft with impact arms and blade elements disposed on the impact arms of the second shaft, wherein at least one of the blade elements disposed on the impact arms of the second shaft has an attitude that is counter to the flow direction of the material to be treated, wherein the first and second shafts are configured to rotate in opposite directions.

21. The device of claim 18 wherein at least two of the blade elements that are not adjacent to one another have an attitude that is counter to the flow direction of the material to be treated.

22. The device of claim 18 wherein free ends of a plurality of the blade elements are disposed along a helical line.

23. The device of claim 18 comprising a second shaft that is parallel to and spaced apart from the first shaft.

24. The device of claim 18 comprising a perforated distribution plate for infeeding the concentrated and/or aqueous solutions/melts from above the material to be treated, wherein the perforated distribution plate is disposed generally horizontally in the trough-type housing.

25. The device of claim 18 comprising an installation for infeeding the concentrated and/or aqueous solutions/melts from above the material to be treated, wherein the installation extends only in a front and/or central region of the trough-type housing when viewed in the flow direction.

26. The device of claim 18 comprising an installation for infeeding additives to the material to be treated, wherein the installation comprises mutually spaced apart ports that are distributed across a length of the trough-type housing.

27. The device of claim 26 wherein the installation is a first installation, the device comprising a second installation for adding ammonia water and/or water vapor onto the material to be treated.

28. The device of claim 27 comprising a third installation for adding ammonia water and/or water vapor, wherein the third installation is disposed above, beside, and/or below a medium to be fluidized, wherein the medium is configured to be impinged with the concentrated and/or aqueous solutions/melts.

29. The device of claim 18 comprising an installation for externally heating the device.

30. The device of claim 18 wherein at least one of the blade elements is positioned in a region of an outfeed zone.

31. The device of claim 18 wherein at least one of the blade elements is positioned in a region of an outfeed zone and has an attitude that is counter to the flow direction.

32. The device of claim 18 comprising a baffle plate that influences gas flow and is disposed in the trough-type housing.

33. The device of claim 18 comprising a motorized drive that is configured to rotate the first shaft, wherein the motorized drive is disposed on an end of the first shaft that faces a product outfeed.

34. The device of claim 18 comprising a motorized drive that is configured to rotate the first shaft, wherein the motorized drive is disposed on an end of the first shaft that faces away from a product outfeed.

35. A method for granulation of concentrated and/or aqueous solutions/melts, the method comprising:
fluidizing particles of a material to be treated in a granulation device that includes a shaft that is rotatably mounted so as to be aligned in a longitudinal direction and blade elements that are attached to the shaft;
conveying the material to be treated in the longitudinal direction of a housing of the granulation device in a flow direction, wherein at least one of the blade elements has an attitude that is counter to the flow direction of the material to be treated; and
rotating and mixing the particles of the material to be treated with the blade elements.

36. The method of claim 35 wherein a dwell time of the material to be treated in the granulation device is increased by the at least one of the blade elements that has the attitude that is counter to the flow direction of the material to be treated.

37. A method for granulation of concentrated and/or aqueous solutions/melts, the method comprising:
fluidizing particles of a material to be treated in the device of claim 18;
conveying the material to be treated in the longitudinal direction of the trough-type housing of the device in the flow direction; and
rotating and mixing the particles of the material to be treated with the blade elements.
